(19) United States
(12) Patent Application Publication
(10) Pub. No.: US 2026/0272170 A1
(43) Pub. Date: Sep. 17, 2026

(54) FURNITURE

(71) Applicant: AuGroup (SHENZHEN) Cross-Border Business Co., Ltd., Shenzhen (CN)

(72) Inventor: Xiangqian Lv, Shenzhen (CN)

(21) Appl. No.: 19/681,969

(22) Filed: May 19, 2026

(30) Foreign Application Priority Data
Apr. 23, 2026 (CN) 202620561569.3

(51) Int. Cl. A47B 96/20; F16B 5/00; F16B 12/10

(52) U.S. Cl. CPC A47B 96/205; F16B 5/0024; F16B 12/10

(57) ABSTRACT

A furniture piece includes a first panel assembly, a second panel assembly, a third panel assembly, and a connecting assembly. The first and third panel assemblies are arranged opposite to each other, with the second panel assembly positioned therebetween. The first panel assembly includes a first joining surface. The second panel assembly includes a second joining surface and an opposite third joining surface. The third panel assembly includes a fourth joining surface. The first and second joining surfaces are in contact, and the third and fourth joining surfaces are in contact. The connecting assembly includes a connecting rod and a mating member. The connecting rod has a head and an opposite connecting end extending through the fourth, third, and second joining surfaces into the third panel assembly. The mating member is embedded in the first joining surface and engages the connecting end, while the head abuts the third panel assembly.

### CROSS REFERENCE TO RELATED APPLICATIONS

This application claims priority to Chinese Patent Application No. CN 202620561569.3, filed April 23, 2026, which is hereby incorporated by reference herein as if set forth in its entirety.

### TECHNICAL FIELD

The present disclosure generally relates to the field of furniture, and in particular relates to a piece of furniture having multiple interconnected panel assemblies.

### BACKGROUND

As the demand for product differentiation continues to rise, everyday items—such as tables and framed structures—are evolving beyond conventional rectangular forms to embrace more distinctive, irregular shapes featuring thickened profiles, beveled edges, and curved surfaces. Taking tables as an example, some designs now feature beveled edges on either the front side or on both the front and back sides. Many of these tables are sold through online channels; to minimize packaging and shipping costs, they are shipped from the factory to the customer as a set of individual components, requiring the user to perform the final assembly themselves by following the provided instructions. However, one drawback of such tables is the sheer number of individual components and the extensive use of connecting hardware involved, which ultimately results in inefficient assembly.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of a piece of furniture according to one embodiment.

FIG. 2 is an isometric exploded view of the furniture.

FIG. 3 is an isometric exploded view of the furniture viewed from another perspective.

FIG. 4 is an isometric exploded view of a second panel assembly of the furniture.

FIG. 5 is an isometric exploded sectional view of the second panel assembly of the furniture.

FIG. 6 is an isometric exploded view of a third panel assembly of the furniture.

FIG. 7 is an isometric exploded view of a third panel assembly of the furniture viewed from a different perspective.

FIG. 8 is a schematic view of a connecting rod passing through a fourth panel assembly and connecting with a mating member embedded within a first panel assembly.

FIG. 9 is a schematic view of the connecting rod passing through the third panel assembly and the fourth panel assembly.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

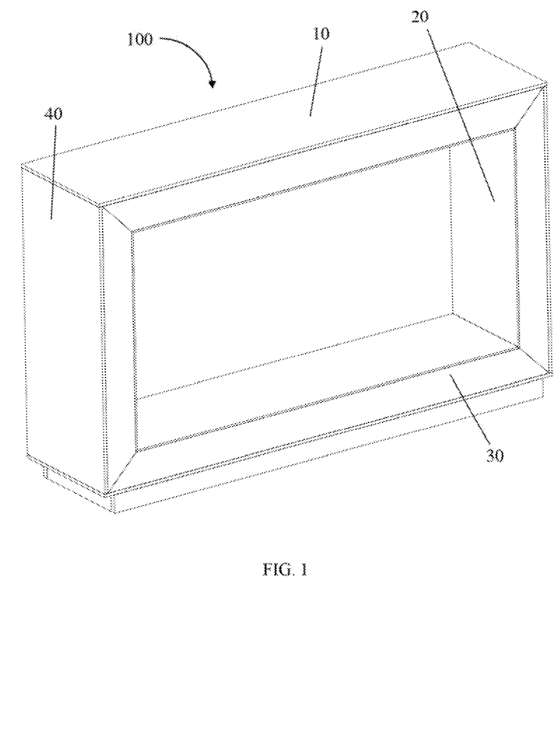

The present disclosure provides a piece of furniture including a number of panel assemblies connected to one another. These connected panel assemblies may serve as a table—for instance, as a decorative table placed in the entryway of a residence—as illustrated in FIG. 1. Upon reviewing the present disclosure, those skilled in the art who grasp the spirit of the present disclosure will recognize that furniture utilizing multiple connected panel assemblies is not limited to decorative tables. In another embodiment, the assembly may serve as the supporting base for other types of furniture; for example, by attaching a tabletop to the upper surface of the structure shown in FIG. 1, one could construct a dining table or a desk. Furthermore, in yet another embodiment, the structure depicted in FIG. 1 could be utilized as a side table intended for use alongside a sofa. The following detailed description will proceed by taking the aforementioned furniture in the specific form of a table as an illustrative example.

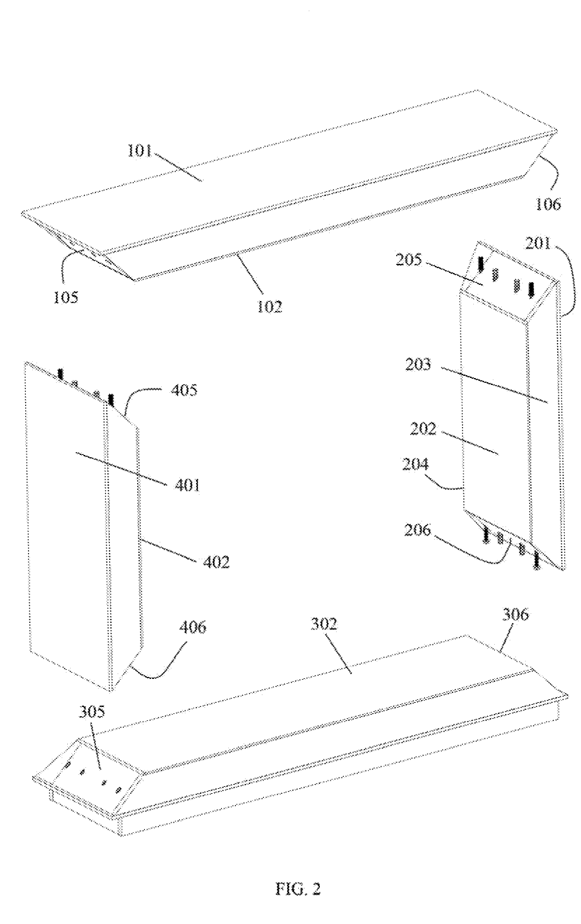

With reference to FIGS. 1 through 3, in one embodiment, the furniture 100 includes a first panel assembly 10, a second panel assembly 20, a third panel assembly 30, and a fourth panel assembly 40, all of which are connected to one another. The first panel assembly 10 and the third panel assembly 30 are positioned opposite to each other; similarly, the second panel assembly 20 and the fourth panel assembly 40 are positioned opposite to each other and located between the first panel assembly 10 and the third panel assembly 30. Furthermore, the direction of extension (i.e., the longitudinal direction) of the second panel assembly 20 intersects with the directions of extension (i.e., the longitudinal directions) of both the first panel assembly 10 and the third panel assembly 30; likewise, the direction of extension (i.e., the longitudinal direction) of the fourth panel assembly 40 intersects with the directions of extension of both the first panel assembly 10 and the third panel assembly 30. In one embodiment, the first panel assembly 10 and the third panel assembly 30 are parallel to each other, while the second panel assembly 20 and the fourth panel assembly 40 are parallel to each other and perpendicular to the first panel assembly 10 and the third panel assembly 30. From the perspective shown in FIG. 1, the second panel assembly 20 and the fourth panel assembly 40 extend in a vertical direction, whereas the directions of extension of the first panel assembly 10 and the third panel assembly 30 are parallel to the horizontal plane. Through this aforementioned construction, the connected first panel assembly 10, second panel assembly 20, third panel assembly 30, and fourth panel assembly 40 collectively form a frame-shaped structure. In other words, the first panel assembly 10, the second panel assembly 20, the third panel assembly 30, and the fourth panel assembly 40 collectively define a through hollow region, the hollow region having a rectangular shape in a corresponding cross section, such that the furniture 100 as a whole has a frame structure. This structure not only facilitates a reduction in overall weight but also provides space for accommodating other functional components or serving as internal storage. It should be noted that the furniture 100 is not limited to a rectangular configuration; rather, it may be constructed in other shapes to suit practical requirements. For instance, in an alternative embodiment, the second panel assembly 20 and the fourth panel assembly 40 are not parallel to each other but extend along directions intersecting each other, such that the furniture 100 as a whole has a trapezoidal shape.

In one embodiment, the first panel assembly 10 and the third panel assembly 30 have similar structures; the second panel assembly 20 and the fourth panel assembly 40 have identical structures; and the manner in which the fourth panel assembly 40 is connected to the first panel assembly 10 and the third panel assembly 30 is the same as the manner in which the second panel assembly 20 is connected to the first panel assembly 10 and the third panel assembly 30.

In one embodiment, the second panel assembly 20 includes an outer surface 201 and an inner surface 202 facing away from each other. The inner surface 202 faces the fourth panel assembly 40. The second panel assembly 20 further includes four side surfaces located between the outer surface 201 and the inner surface 202: specifically, a first side surface 203, a second side surface 204, a third side surface 205, and a fourth side surface 206. The first side surface 203 and the second side surface 204 are respectively located at the two ends of the second panel assembly 20 in the widthwise direction, while the third side surface 205 and the fourth side surface 206 are respectively located at the two ends of the second panel assembly 20 in the lengthwise direction. In one embodiment, the first side surface 203 and the second side surface 204 are both inclined surfaces angled relative to the outer surface 201 and the inner surface 202, serving a decorative function. Through this arrangement, the aesthetic appearance can be enhanced without significantly increasing structural complexity, thereby endowing the product with a superior sense of visual layering and decorative appeal. In another embodiment, the first side surface 203 and the second side surface 204 are both planar surfaces perpendicular to the outer surface 201 and the inner surface 202. In one embodiment, the third side surface 205 and the fourth side surface 206 are both inclined surfaces angled relative to the outer surface 201 and the inner surface 202. The third side surface 205 is also referred to as the top end face 205 or the joining surface 205, while the fourth side surface 206 is also referred to as the bottom end face 206 or the joining surface 206.

In one embodiment, the fourth panel assembly 40 and the second panel assembly 20 share an identical construction. Specifically, the fourth panel assembly 40 includes an outer surface 401 and an inner surface 402 facing away from each other. The inner surface 402 faces the second panel assembly 20—more precisely, it faces the inner surface 202 of the second panel assembly 20. The fourth panel assembly 40 further includes four side surfaces located between the outer surface 401 and the inner surface 402. The side surfaces include two decorative inclined surfaces located at the respective ends of the fourth panel assembly 40 in its widthwise direction, as well as two inclined surfaces, 405 and 406, located at the respective ends of the fourth panel assembly 40 in its lengthwise direction. The inclined surface 405 is also referred to as the top end face 405 or the joining face 405, while the inclined surface 406 is also referred to as the bottom end face 406 or the joining face 406.

In one embodiment, the first panel assembly 10 includes an outer surface 101 and an inner surface 102 facing away from each other. The inner surface 102 faces the third panel assembly 30. The first panel assembly 10 further includes four side surfaces located between the outer surface 101 and the inner surface 102. The side surfaces include two decorative inclined surfaces located at the respective ends of the first panel assembly 10 in its widthwise direction, as well as two inclined surfaces, 105 and 106, located at the respective ends of the first panel assembly 10 in its lengthwise direction. The inclined surface 105 is also referred to as the left end face 105 or the joining face 105, while the inclined surface 106 is also referred to as the right end face 106 or the joining face 106.

In one embodiment, the third panel assembly 30 includes an outer surface 301 and an inner surface 302 facing away from each other. The inner surface 302 faces the first panel assembly 10—specifically, the inner surface 102 of the first panel assembly 10. The third panel assembly 30 further includes four side surfaces located between the outer surface 301 and the inner surface 302. The side surfaces include two decorative inclined surfaces located at the respective ends of the third panel assembly 30 in the widthwise direction, and two inclined surfaces, 305 and 306, located at the respective ends of the third panel assembly 30 in the lengthwise direction. The inclined surface 305 is also referred to as the left end face 305 or the joining face 305, while the inclined surface 306 is also referred to as the right end face 306 or the joining face 306.

In one embodiment, the left end face 105 and the right end face 106 of the first panel assembly 10 abut against the top end face 405 of the fourth panel assembly 40 and the top end face 205 of the second panel assembly 20, respectively; meanwhile, the left end face 305 and the right end face 306 of the third panel assembly 30 abut against the bottom end face 406 of the fourth panel assembly 40 and the bottom end face 206 of the second panel assembly 20, respectively.

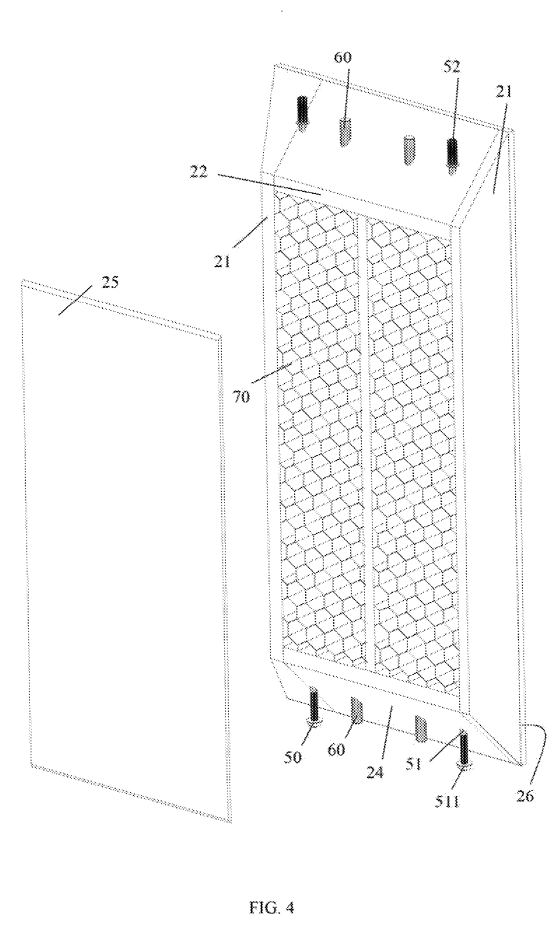

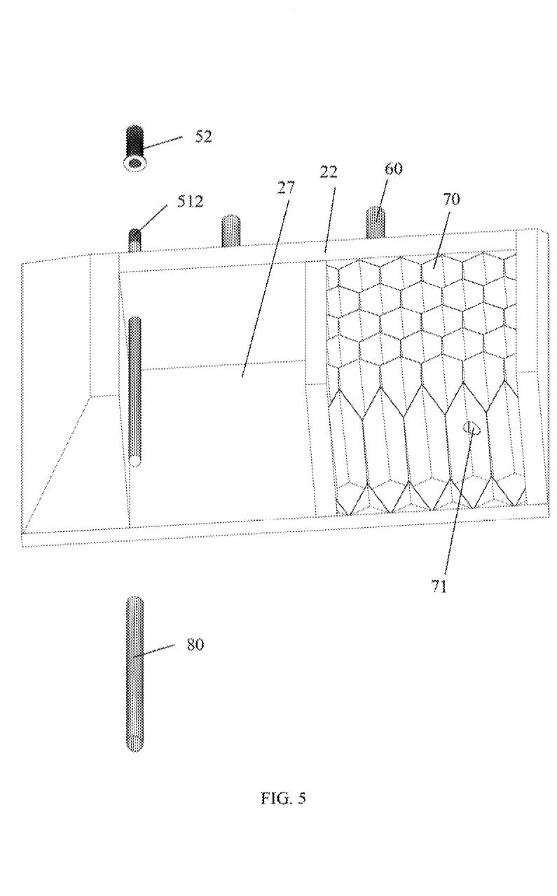

Referring to FIGS. 4 and 5, in one embodiment, the furniture 100 further includes a connecting assembly 50. This connecting assembly 50 includes a connecting rod 51 and a mating member 52. The connecting rod 51 includes a head 511 and a connecting end 512 opposite to the head 511. The connecting end 512 of the connecting rod 51 extends into the third panel assembly 30 from the side of the third panel assembly 30 facing away from its right end face 306, and successively passes through the right end face 306, the bottom end face 206 and the top end face 205 of the second panel assembly 20. The mating member 52 is embedded within the right end face 106 of the first panel assembly 10, and the connecting end 512 of the connecting rod 51 is connected with the mating member 52. The head 511 of the connecting rod 51 abuts against the side of the third panel assembly 30 facing away from the right end face 306, thereby connecting the first panel assembly 10, the second panel assembly 20, and the third panel assembly 30 together. The fourth panel assembly 40 is connected to the first panel assembly 10 and the third panel assembly 30 in the same manner.

By means of the aforementioned structure, the main components of the furniture 100—namely, the first panel assembly 10, the second panel assembly 20, the third panel assembly 30, and the fourth panel assembly 40—can be connected together using the simply constructed connecting assembly 50, thereby facilitating easy and rapid assembly of the furniture 100 by the user.

With reference to FIG. 4, in one embodiment, the second panel assembly 20 includes two side panels 21, an upper solid block 22, a lower solid block 24, an inner cover panel 25, and an outer cover panel 26. The two side panels 21 are thin-walled, rectangular flat panels spaced apart from each other. In one embodiment, the two side panels 21 are parallel to each other, thereby collectively defining the dimensional extent of the second panel assembly 20 in the thickness direction. The inner cover panel 25 faces the fourth panel assembly 40; the inner surface 202 is the surface of the inner cover panel 25 that faces the fourth panel assembly 40. Both the length and the width of the inner cover panel 25 are respectively smaller than the length and the width of the outer cover panel 26. The outer surface 201 is the surface of the outer cover panel 26 that faces away from the fourth panel assembly 40.

In one embodiment, each side panel 21 is substantially trapezoidal in shape, having a long edge abutting the outer cover panel 26, a short edge abutting the inner cover panel 25, and a top edge and a bottom edge between the long and short edges; both the top and bottom edges are inclined relative to the inner cover panel 25 and the outer cover panel 26. The first side surface 203 and the second side surface 204 constitute the respective outer surfaces of the two side panels 21 that face away from each other.

The upper solid block 22 and the lower solid block 24 are spaced apart from each other. In one embodiment, the upper solid block 22 is positioned between the two side panels 21. The bottom surface of the upper solid block 22 abuts the outer cover panel 26, and the upper solid block 22 is arranged at the top end of the outer cover panel 26, with its respective ends—along its longitudinal direction—abutting the two side panels 21. The top end face 205 is an inclined surface formed on the upper solid block 22, facing away from the lower solid block 24. In one embodiment, the top end face 205 is flush with the top edges of the two side panels 21, thereby facilitating engagement with the first panel assembly 10.

In one embodiment, the lower solid block 24 is located between the two side panels 21. The bottom surface of the lower solid block 24 abuts the outer cover panel 26, and the lower solid block 24 is arranged at the bottom end of the outer cover panel 26. At opposite ends along its longitudinal direction, the lower solid block 24 abuts the two respective side panels 21. The bottom end face 206 is an inclined surface formed on the lower solid block 24, facing away from the upper solid block 22. In one embodiment, the bottom end face 206 is flush with the bottom edges of the two side panels 21, thereby facilitating engagement with the third panel assembly 30.

In one embodiment, the two side panels 21, the upper solid block 22, and the lower solid block 24 are sandwiched between the inner cover panel 25 and the outer cover panel 26. The upper solid block 22 and the lower solid block 24 may be secured to the two side panels 21 via bonding (i.e., adhesion). Furthermore, the two side panels 21, the upper solid block 22, and the lower solid block 24 may be secured to the inner cover panel 25 and the outer cover panel 26, respectively, via bonding, thereby forming an integrated structure. In other alternative embodiments, the aforementioned components may also be secured to one another via screws, riveting, snap-fit connections, or similar methods, in order to meet varying strength requirements and assembly process needs.

In one embodiment, both the upper solid block 22 and the lower solid block 24 are provided with through holes configured to allow the connecting rod 51 of the connecting assembly 50 to pass therethrough. The through hole of the upper solid block 22 and the through hole of the lower solid block 24 each have a sufficient length, such that the connecting rod 51 extending through the upper solid block 22 and the lower solid block 24 can fully contact inner surfaces of the through holes of the upper solid block 22 and the lower solid block 24, thereby improving connection stability. By increasing the lengths of the through holes of the upper solid block 22 and the lower solid block 24, the contact area between the connecting rod 51 and the upper solid block 22 and the lower solid block 24 can be increased, such that loads can be transmitted and distributed over a larger area, thereby improving the load-bearing capacity and durability of the overall connection structure.

In one embodiment, the two side panels 21, the upper solid block 22, and the lower solid block 24 cooperatively define a receiving space 27 see FIG. 5. The through hole of the upper solid block 22 extends from a surface thereof opposite to the top end face 205 to the top end face 205, and the through hole of the lower solid block 24 extends from a surface thereof opposite to the bottom end face 206 to the bottom end face 206. Through such a configuration, the connecting rod 51 is capable of extending into the second panel assembly 20 from the bottom end face 206 of the lower solid block 24 and extending out from the top end face 205 of the second panel assembly 20. Specifically, the connecting end 512 of the connecting rod 51 extends into and through the lower solid block 24 from the bottom end face 206 thereof. Thereafter, after passing through the receiving space 27, the connecting end 512 of the connecting rod 51 passes through the through hole of the upper solid block 22 and extends through the upper solid block 22, and further extends out from the top end face 205 of the upper solid block 22, as shown in FIG. 4.

The fourth panel assembly 40 has the same configuration as the second panel assembly 20. Specifically, the fourth panel assembly 40 includes two side panels, an upper solid block, and a lower solid block, which are sandwiched between an inner cover panel and an outer cover panel. The two side panels, the upper solid block, and the lower solid block cooperatively define a receiving space. Both the upper solid block and the lower solid block are provided with through holes configured to allow the connecting rod 51 of the connecting assembly 50 to pass therethrough. The through hole of the upper solid block and the through hole of the lower solid block each have a sufficient length, such that the connecting rod 51 extending through the upper solid block and the lower solid block can fully contact inner surfaces of the through holes of the upper solid block and the lower solid block. Through such a configuration, the connecting rod 51 is capable of extending into the fourth panel assembly 40 from the bottom end face 406 of the lower solid block and extending out from the top end face 405 of the fourth panel assembly 40. The specific structures of the above-described elements of the fourth panel assembly 40 and the connection relationships among the components thereof may refer to those of the second panel assembly 20, and details thereof are not repeated herein.

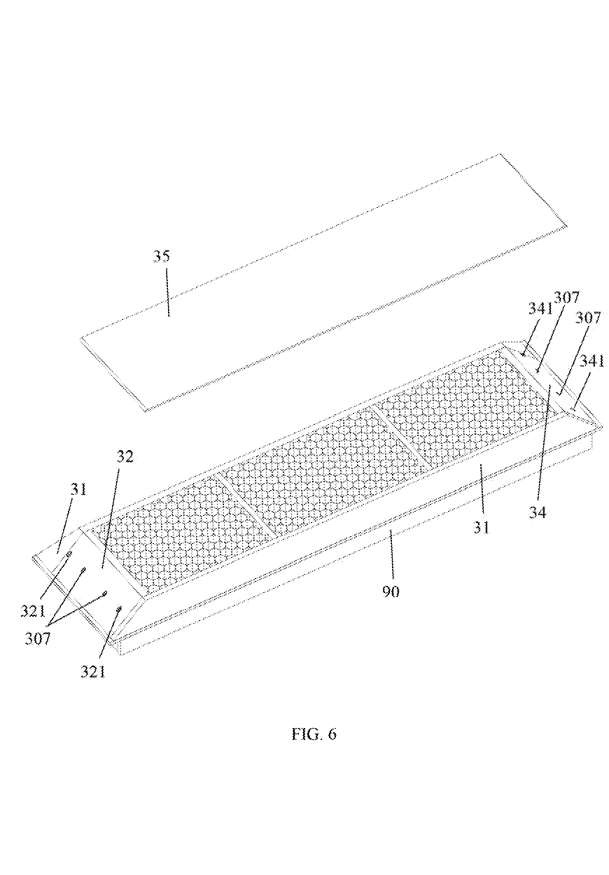

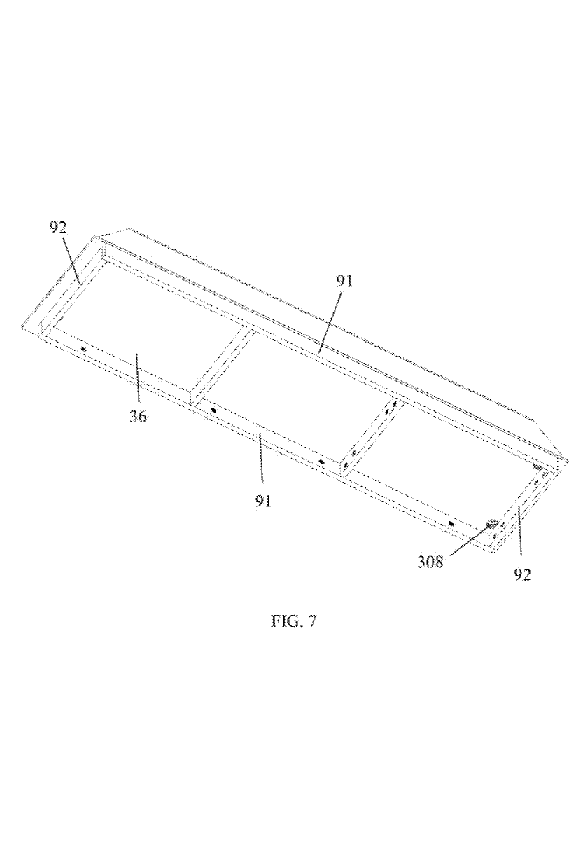

Referring to both FIGS. 6 and 7, the third panel assembly 30 has a configuration similar to that of the second panel assembly 20. Specifically, the third panel assembly 30 includes two side panels 31, a left solid block 32, a right solid block 34, an inner cover panel 35, and an outer cover panel 36. The two side panels 31 are thin-walled rectangular panels spaced apart from each other. In one embodiment, the two side panels 31 are parallel to each other, thereby jointly defining a dimensional range of the third panel assembly 30 in a thickness direction. The inner cover panel 35 is opposite to the first panel assembly 10, and the inner surface 302 is a surface of the inner cover panel 35 facing the first panel assembly 10. The length and width of the inner cover panel 35 are both smaller than the length and width of the outer cover panel 36, respectively. The outer surface 301 is a surface of the outer cover panel 36 facing away from the first panel assembly 10.

In one embodiment, each side panel 31 is substantially trapezoidal and includes a long edge attached to the outer cover panel 36, a short edge attached to the inner cover panel 35, and a left edge and a right edge located between the long edge and the short edge. The left edge and the right edge are both inclined relative to the inner cover panel 35 and the outer cover panel 36. The two decorative inclined surfaces are respectively outer side surfaces of the two side panels 31 facing away from each other.

The left solid block 32 and the right solid block 34 are spaced apart from each other. In one embodiment, the left solid block 32 is located between the two side panels 31, and a bottom surface of the left solid block 32 is attached to the outer cover panel 36. The left solid block 32 is located at a left end of the outer cover panel 36, and the two opposite ends of the left solid block 32 in a lengthwise direction thereof are respectively attached to the two side panels 31. The left end face 305 is an inclined surface formed on the left solid block 32 and facing away from the right solid block 34. In one embodiment, the left end face 305 is flush with the left edges of the two side panels 31, thereby facilitating engagement with the fourth panel assembly 40.

In one embodiment, the right solid block 34 is located between the two side panels 31, and a bottom surface of the right solid block 34 is attached to the outer cover panel 36. The right solid block 34 is located at a right end of the outer cover panel 36, and the two opposite ends of the right solid block 34 in a lengthwise direction thereof are respectively attached to the two side panels 31. The right end face 306 is an inclined surface formed on the right solid block 34 and facing away from the left solid block 32. In one embodiment, the right end face 306 is flush with the right edges of the two side panels 31, thereby facilitating engagement with the second panel assembly 20. In one embodiment, both the left solid block 32 and the right solid block 34 are provided with through holes 321 and 341 see FIG. 6 configured to allow the connecting rod 51 of the connecting assembly 50 to pass therethrough. The through hole 321 of the left solid block 32 extends from a surface thereof opposite to the left end face 305 to the left end face 305, and the through hole 341 of the right solid block 34 extends from a surface thereof opposite to the right end face 306 to the right end face 306.

In one embodiment, the two side panels 31, the left solid block 32, and the right solid block 34 are sandwiched between the inner cover panel 35 and the outer cover panel 36. The left solid block 32 and the right solid block 34 may be fixed to the two side panels 31 by adhesive bonding, and the two side panels 31, the left solid block 32, and the right solid block 34 may be respectively fixed to the inner cover panel 35 and the outer cover panel 36 by adhesive bonding, thereby forming an integrated structure. In other alternative embodiments, the above-described components may be fixed to one another by screws, riveting, snap-fit connection, or the like, so as to satisfy different strength requirements and assembly process requirements. The two side panels 31, the left solid block 32, and the right solid block 34 cooperatively define a receiving space.

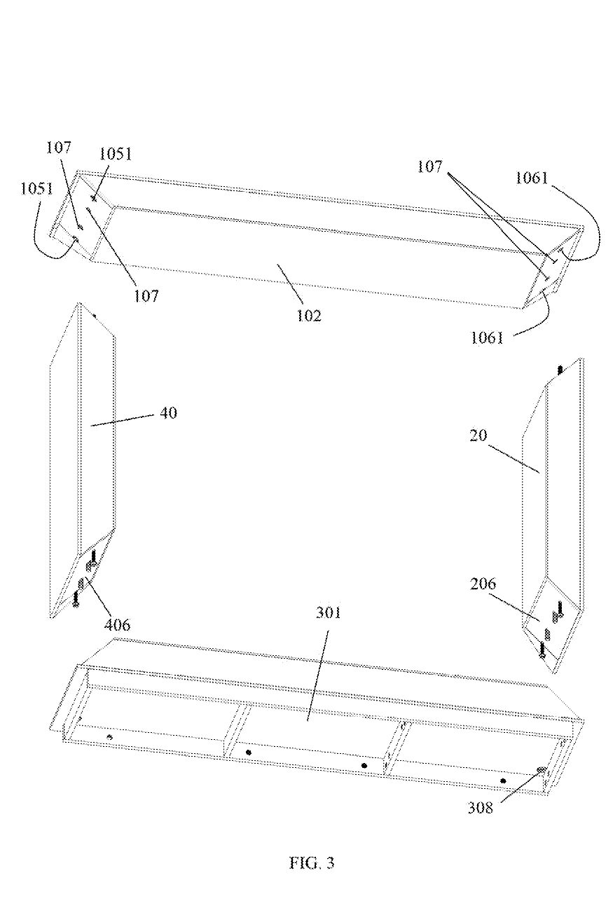

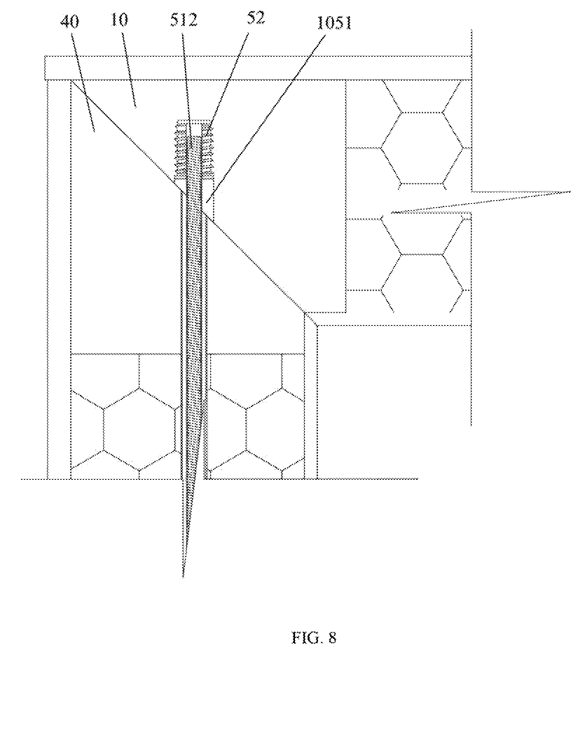

The first panel assembly 10 has a configuration similar to that of the third panel assembly 30. Specifically, the first panel assembly 10 includes two side panels, a left solid block, and a right solid block, which are sandwiched between an inner cover panel and an outer cover panel. The two side panels, the left solid block, and the right solid block cooperatively define a receiving space. The specific structures of the above-described components of the first panel assembly 10 and the connection relationships among the components thereof may refer to those of the third panel assembly 30, and details thereof are not repeated herein. In one embodiment, a receiving hole 1051 see FIGS. 3 and 8 configured to receive the mating member 52 is formed in a left end face 105 of the left solid block of the first panel assembly 10, and a receiving hole 1061 see FIG. 3 configured to receive the mating member 52 is formed in a right end face 106 of the right solid block of the first panel assembly 10.

In one embodiment, the furniture 100 further includes a number of positioning pins 60 see FIG. 4. When the second panel assembly 20 is connected to the first panel assembly 10 and the third panel assembly 30, the positioning pins 60 are to position the second panel assembly 20 relative to the first panel assembly 10 and the third panel assembly 30. This allows the through holes on the top end face 205 of the second panel assembly 20 to be aligned with the mating members 52 on the right end face 106 of the first panel assembly 10 and allows the through holes on the bottom end face 206 of the second panel assembly 20 to be aligned with the through hole 341 on the right end face 306 of the third panel assembly 30. Thereafter, a user may conveniently cause the connecting rod 51 to sequentially pass through the third panel assembly 30 and the second panel assembly 20 and finally connect with the mating member 52. Similarly, when the fourth panel assembly 40 is connected to the first panel assembly 10 and the third panel assembly 30, the positioning pins 60 are further configured to position the fourth panel assembly 40 relative to the first panel assembly 10 and the third panel assembly 30. This allows the through holes on the top end face 405 of the fourth panel assembly 40 to be aligned with the mating members 52 on the left end face 105 of the first panel assembly 10 and allows the through holes on the bottom end face 406 of the fourth panel assembly 40 to be aligned with the through holes 321 on the left end face 305 of the third panel assembly 30.

In one embodiment, both the top end face 205 and the bottom end face 206 of the second panel assembly 20 are provided with receiving holes configured to receive the positioning pins 60. Similarly, both the top end face 405 and the bottom end face 406 of the fourth panel assembly 40 are provided with receiving holes configured to receive the positioning pins 60. During assembly, the user inserts the positioning pins 60 into the receiving holes formed in the top end face 205 and the bottom end face 206 of the second panel assembly 20, such that the positioning pins 60 respectively protrude from the top end face 205 and the bottom end face 206 of the second panel assembly 20. Similarly, the user inserts the positioning pins 60 into the receiving holes formed in the top end face 405 and the bottom end face 406 of the fourth panel assembly 40, such that the positioning pins 60 respectively protrude from the top end face 405 and the bottom end face 406 of the fourth panel assembly 40.

The left end face 105 and the right end face 106 of the first panel assembly 10 are both provided with positioning holes 107 see FIG. 3, and the left end face 305 and the right end face 306 of the third panel assembly 30 are both provided with positioning holes 307 see FIG. 6. When positioning the second panel assembly 20 relative to the first panel assembly 10 and the third panel assembly 30, the user may align the positioning holes 107 of the first panel assembly 10 with the positioning pins 60 protruding from the top end face 205 of the second panel assembly 20 and then move the first panel assembly 10 toward the second panel assembly 20 until the positioning pins 60 are inserted into the positioning holes 107. Thereafter, the user may align the positioning holes 307 of the third panel assembly 30 with the positioning pins 60 protruding from the bottom end face 206 of the second panel assembly 20 and then move the third panel assembly 30 toward the second panel assembly 20 until the positioning pins 60 are inserted into the positioning holes 307. In this way, the second panel assembly 20 is positioned between the first panel assembly 10 and the third panel assembly 30. A similar approach may be used to position the fourth panel assembly 40 between the first panel assembly 10 and the third panel assembly 30.

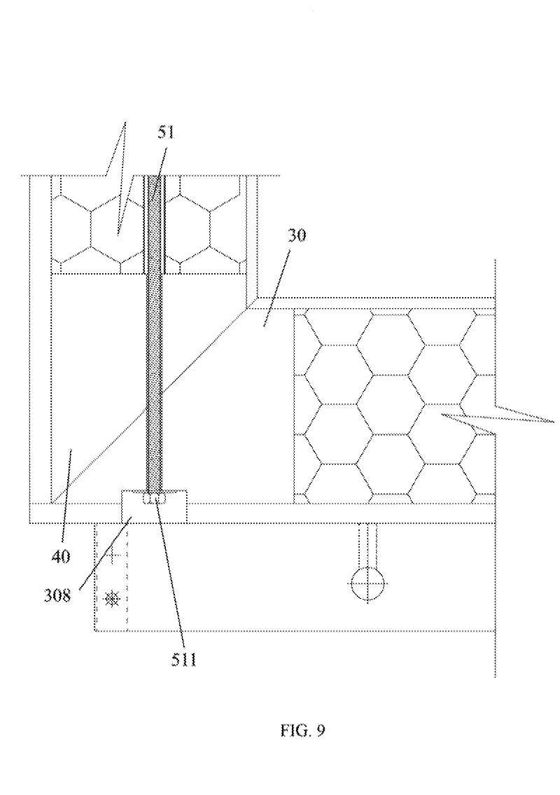

In one embodiment, each mating member 52 is a hollow cylinder provided with a threaded hole. In one embodiment, an interference fit is formed between the mating member 52 and a receiving hole of the first panel assembly 10, such that the mating member 52 can be firmly fixed to the first panel assembly 10. A circumferential side surface of the connecting end 512 of the connecting rod 51 is provided with an external thread, and the head 511 of the connecting rod 51 is provided with a socket (e.g., an internal hexagonal socket). In this manner, a user may use a tool (e.g., an Allen wrench) engaged with the socket of the head 511 to apply torque to the connecting rod 51, such that the connecting end 512 can be screwed into the threaded hole of the mating member 52, thereby achieving connection between the connecting rod 51 and the mating member 52. In another embodiment, the head 511 may be replaced by a nut threadedly connected to the connecting rod 51. In either case, in one embodiment, a surface of the third panel assembly 30 opposite to the first panel assembly 10 (i.e., the outer surface 301 of the third panel assembly 30) is provided with a through hole 308 communicating with the through hole 321 of the left solid block 32 and the through hole 341 of the right solid block 34, as shown in FIGS. 3 and 7. In one embodiment, the diameter of the through hole 308 is larger than the diameters of the through holes 321 and 341, such that each connecting rod 51 passes through a corresponding through hole 308 and then through the through hole 321/341. The head 511 may be partially or fully received in the through hole 308 as shown in FIG. 9 and abuts against the left solid block 32 or the right solid block 34. In another embodiment, the diameter of the through hole 308 is equal to the diameters of the through holes 321 and 341, and the head portion 511 abuts against the outer surface 301 of the third panel assembly 30. It is understood that the connecting rod 51 and the mating member 52 are not limited to being connected by threaded engagement, and in other embodiments, they may be fixed together by snap-fit connection.

Referring to FIGS. 3 to 5, in one embodiment, a filling core 70 is provided inside the second panel assembly 20. The filling core 70 may be made of a lightweight filling material, such as a honeycomb paper structure. By providing the filling core 70 in the second panel assembly 20, the overall weight can be effectively reduced while ensuring structural strength, thereby improving the lightweight performance and material utilization efficiency of the furniture 100.

In one embodiment, the filling core 70 may be filled within the receiving space 27 defined by the two side panels 21, the upper solid block 22, the lower solid block 24, the inner cover panel 25, and the outer cover panel 26, and may be in contact with the above components, so as to provide support for the inner cover panel 25 and the outer cover panel 26, thereby improving the deformation resistance of the second panel assembly 20 under compression or bending conditions. The filling core 70 may be fixed within the receiving space 27 by adhesive bonding, for example, being bonded to an inner surface of the inner cover panel 25 and/or the outer cover panel 26, so as to prevent displacement or loosening of the filling core 70 during use.

In other alternative embodiments, the filling core 70 may be made of a foam material (e.g., polyurethane foam), a wood-based filling material, a plastic honeycomb structure, or other lightweight high-strength materials, so as to meet different requirements for strength, weight, and cost. In addition, in some embodiments, the filling core 70 may be an integral structure, or may be formed by assembling a number of filling units, so as to facilitate manufacturing and assembly. It should be understood that the material type, structural form, and arrangement manner of the filling core 70 within the receiving space 27 may be adjusted according to actual requirements, and should not be construed as limiting the scope of the present disclosure.

In one embodiment, the filling core 70 is provided with a through hole 71 see FIG. 5 configured to allow the connecting rod 51 to pass therethrough. The through hole 71 communicates with the through hole on the top end face 205 and the through hole on the bottom end face 206 of the second panel assembly 20. In this way, after the connecting end 512 of the connecting rod 51 passes through the lower solid block 24 of the second panel assembly 20, it further passes through the through hole 71 of the filling core 70 and then passes through the upper solid block 22.

In another embodiment, the furniture 100 further includes a guide tube 80 disposed in the receiving space 27 and extending through a through hole of the filling core 70. The guide tube 80 extends along a lengthwise direction of the second panel assembly 20 and is in communication with the through hole on the top end face 205 and the through hole on the bottom end face 206 of the second panel assembly 20, thereby forming a continuous guide channel inside the second panel assembly 20. The guide tube 80 is made of a rigid material, such as plastic or metal. The guide tube 80 has a continuous smooth inner surface, thereby providing a stable guiding function during insertion of the connecting rod 51 and reducing frictional resistance, so that the connecting rod 51 can smoothly pass through the guide tube 80. By providing the guide tube 80, the connecting rod 51 can be effectively guided when passing through the second panel assembly 20, thereby preventing deviation or jamming in the region of the filling core 70 and improving assembly efficiency and assembly success rate. During assembly, after the connecting end of the connecting rod 51 is inserted from a bottom end of the second panel assembly 20 and passes through the lower solid block 24, the connecting rod 51 passes through the region where the filling core 70 is located under the guiding effect of the guide tube 80 and then continues upward through the upper solid block 22, thereby enabling smooth penetration of the connecting rod 51 through the second panel assembly 20.

The fourth panel assembly 40 has the same configuration as the second panel assembly 20. That is, a filling core is provided inside the fourth panel assembly 40, and details thereof are not repeated herein.

Similarly, like the second panel assembly 20, filling cores are also provided in the receiving spaces of the first panel assembly 10 and the third panel assembly 30. The functions of these filling cores are the same as that of the filling core 70, and details thereof are not repeated herein.

Referring to FIGS. 6 and 7, in one embodiment, a side (i.e., a bottom surface of the outer cover panel 36 facing away from the first panel assembly 10) of the third panel assembly 30 opposite to the first panel assembly 10 is provided with a skirting board 90 protruding therefrom and formed by a number of support plates. In one embodiment, the support plates include two long support plates 91 parallel to each other and two short support plates 92 parallel to each other. The skirting board 90 serves as a buffer layer between the main body (i.e., the first panel assembly 10, the second panel assembly 20, the third panel assembly 30, and the fourth panel assembly 40 connected to one another) of the furniture 100 and the ground, and can effectively prevent a mop, broom, or a user's foot from directly impacting a bottom portion of the main body, thereby avoiding moisture-induced deformation of the panels or damage to a coated surface. The support plates 91 and 92 may be connected to the outer cover panel 36 by known connecting means. For example, an eccentric connector may be used to achieve the connection between the support plates 91 and 92 and the outer cover panel 36.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A piece of furniture, comprising:
a first panel assembly, a second panel assembly, and a third panel assembly, wherein the first panel assembly and the third panel assembly are positioned opposite to each other, the second panel assembly is arranged between the first panel assembly and the third panel assembly, and an extending direction of the second panel assembly intersects with an extending direction of each of the first panel assembly and the third panel assembly; the first panel assembly comprises a first joining surface; the second panel assembly comprises a second joining surface and a third joining surface positioned opposite to the second joining surface; and the third panel assembly comprises a fourth joining surface; the first joining surface and the second joining surface are in contact with each other, and the third joining surface and the fourth joining surface are in contact with each other; and
a connecting assembly comprising a connecting rod and a mating member, the connecting rod comprising a head and a connecting end opposite to the head, the connecting end of the connecting rod extending into the third panel assembly from a side of the third panel assembly facing away from the fourth joining surface, and sequentially passing through the fourth joining surface, the third joining surface, and the second joining surface; the mating member being embedded within the first joining surface; the connecting end of the connecting rod being connected with the mating member; and the head of the connecting rod abutting against the side of the third panel assembly facing away from the fourth joining surface, thereby connecting the first panel assembly, the second panel assembly, and the third panel assembly together.

2. The piece of furniture of claim 1, wherein at least one of the following conditions is satisfied: (i) the first joining surface and the second joining surface are inclined surfaces; and (ii) the third joining surface and the fourth joining surface are inclined surfaces.

3. The piece of furniture of claim 1, further comprising positioning pins protruding respectively from the second joining surface and the third joining surface, wherein the first joining surface and the fourth joining surface each define a positioning hole; and the positioning pins are respectively received within the positioning holes, thereby positioning the first panel assembly and the third panel assembly relative to the second panel assembly.

4. The piece of furniture of claim 1, wherein the second panel assembly comprises two side panels, an upper solid block, a lower solid block, an inner cover panel, and an outer cover panel; the two side panels are spaced apart from each other; the upper solid block and the lower solid block are spaced apart from each other; the two side panels, the upper solid block, and the lower solid block are arranged between the inner cover panel and the outer cover panel and collectively define a receiving space; and the second joining surface and the third joining surface are formed on the upper solid block and the lower solid block, respectively.

5. The piece of furniture of claim 4, further comprising a filling core disposed within the receiving space.

6. The piece of furniture of claim 5, further comprising a guide tube disposed within the receiving space and passing through the filling core, wherein the connecting rod passes sequentially through the lower solid block, the guide tube, and the upper solid block.

7. A piece of furniture, comprising:
a first panel assembly, a second panel assembly, and a third panel assembly, wherein the first panel assembly and the third panel assembly are parallel to each other; the second panel assembly is positioned between the first panel assembly and the third panel assembly; and an extending direction of the second panel assembly intersects with an extending direction of each of the first panel assembly and the third panel assembly; one end face of the first panel assembly abuts against a top end face of the second panel assembly, and a bottom end face of the second panel assembly abuts against one end face of the third panel assembly; and
a connecting assembly comprising a connecting rod and a mating member; the connecting rod comprising a head and a connecting end opposite to the head; the connecting end of the connecting rod passing through the third panel assembly, extending inward into the second panel assembly from the bottom end face thereof, and extending out from the top end face thereof; the mating member being embedded within the end face of the first panel assembly, and the connecting end of the connecting rod being connected with the mating member; and the head of the connecting rod abuts against a surface of the third panel assembly that faces away from the first panel assembly, thereby connecting the first panel assembly, the second panel assembly, and the third panel assembly together.

8. The piece of furniture of claim 7, wherein at least one of the following conditions is satisfied: (i) the end face of the first panel assembly and the top end face of the second panel assembly are inclined surfaces; and (ii) the bottom end face of the second panel assembly and the end face of the third panel assembly are inclined surfaces.

9. The piece of furniture of claim 7, wherein the second panel assembly comprises two side panels, an upper solid block, a lower solid block, an inner cover panel, and an outer cover panel; the two side panels are spaced apart from each other; the upper solid block and the lower solid block are spaced apart from each other; the two side panels, the upper solid block, and the lower solid block are arranged between the inner cover panel and the outer cover panel and collectively define a receiving space; and the top end face and the bottom end face are formed on the upper solid block and the lower solid block, respectively.

10. The piece of furniture of claim 9, further comprising a filling core and a guide tube disposed within the receiving space, wherein the guide tube passes through the filling core, and the connecting rod passes sequentially through the lower solid block, the guide tube, and the upper solid block.
